(19) United States
(12) Patent Application Publication
(10) Pub. No.: US 2020/0107565 A1
(43) Pub. Date: Apr. 9, 2020

(54) SMOKE INJECTOR FOR A FOOD PRODUCT

(71) Applicant: Electrolux Home Products, Inc., Charlotte, NC (US)

(72) Inventors: Steven Swayne, Nashville, TN (US); Andrew Worley, Springfield, TN (US)

(21) Appl. No.: 16/151,535

(22) Filed: Oct. 4, 2018

(51) Int. Cl. A23L 13/70; A23B 4/052; A23L 13/40

(52) U.S. Cl. CPC A23L 13/72; A23L 13/428; A23B 4/052

(57) ABSTRACT

A device for injecting dry smoke into a food product is disclosed. The device includes a smoke injector having an external wall with a plurality of apertures formed therein that communicate with a smoke-injector conduit. The smoke-injector conduit is in fluid communication with a smoke reservoir that houses dry smoking media therein. A fan directs dry smoke produced from said dry smoking media into the smoke-injector conduit such that the dry smoke is eluted through said plurality of apertures in order to introduce said dry smoke to an interior of the food product when impaled by said smoke injector.

### BACKGROUND OF THE INVENTION

### 1. Field of the Invention

This application relates generally to a smoke injector and, more specifically, to a device for injecting dry smoke into a food product, particularly meat.

### 2. Description of Related Art

There are various methods for preparing (i.e., cooking) a food product, particularly meat, such as baking (in an oven), broiling, pan-frying, searing, grilling, etc. Smoking is another meat preparation method that provides unique flavoring. Conventionally, smoking meats is a long and slow process that can have widely varying results. This variability arises due to the complex interaction of smoke on the surface of the meat and the difficulty in getting the smoke to penetrate into the meat. For example, after being smoked, the external surface of the meat and the outermost areas of the meat generally have more flavoring than the innermost areas of the meat. As such, in attempt to acquire a flavorful innermost area, a user may leave the meat in the smoking device for a longer time period than is necessary, ultimately overcooking the meat.

### BRIEF SUMMARY OF THE INVENTION

In accordance with one aspect, there is provided a device for injecting dry smoke into a food product. The device includes a smoke injector configured to impale a food product. The smoke injector has an external wall defining a smoke-injector conduit. A plurality of apertures in the external wall provide fluid communication therethrough. A smoke reservoir is remote from and in fluid communication with the smoke-injector conduit. The smoke reservoir is configured to house dry smoking media therein. The device further includes a first fan for directing dry smoke produced from dry smoking media in the smoke reservoir into the smoke-injector conduit such that the dry smoke is eluted through the plurality of apertures in order to introduce the dry smoke to an interior of the food product when impaled by the smoke injector.

In accordance with another aspect, there is provided a smoker assembly that injects dry smoke into a food product. The smoker assembly includes a housing that defines a smoking space therein for housing the food product to be smoked. A pan is disposed below a bottom wall of the housing such that a cavity is defined between the bottom wall and the pan. The smoker assembly further includes a first smoke injector having a first external wall defining a first smoke-injector conduit and having a plurality of first apertures formed therein to provide communication through the first external wall. The first external wall has a first end and a second end. The first end of the first external wall is conically shaped and has a first end aperture formed in a tip thereof. A manifold extends within the cavity and includes a first outlet port for removably coupling the first smoke injector. A smoke reservoir is remote from and in fluid communication with the manifold. The smoke reservoir is configured to house dry smoking media therein. A first fan directs dry smoke produced from dry smoking media in the smoke reservoir into the manifold such that the dry smoke is delivered from the manifold and eluted through the plurality of first apertures in order to introduce dry smoke to an interior of a food product within the smoking space when impaled by the first smoke injector.

In accordance with a further aspect, there is provided a smoker assembly that injects dry smoke into a food product. The smoker assembly includes a housing that defines a smoking space therein for housing the food product to be smoked. The smoker assembly further includes a smoke injector having an elongated hollow tube with a plurality of apertures that provide communication between a smoke-injector conduit formed within the tube and a space outside of said tube. The smoke injector extends between opposing sidewalls of, and through, the housing. A smoke reservoir is remote from and in fluid communication with the smoke-injector conduit. The smoke reservoir houses a dry smoking media therein. The smoker assembly also includes a first fan that directs dry smoke produced from the dry smoking media in the smoke reservoir into the smoke-injector conduit such that the dry smoke is eluted through the plurality of apertures in order to introduce dry smoke to an interior of the food product when impaled by the smoke injector.

### BRIEF DESCRIPTION OF SEVERAL VIEWS OF THE DRAWING

FIG. 1 is a perspective view of a smoke injector;

FIG. 2 is a longitudinal cross-sectional view of the smoke injector of FIG. 1 taken along the line 2-2;

FIG. 3 is a schematic side view, partially in section, of an embodiment of a device for injecting dry smoke into a food product;

FIG. 4 is a schematic side view, partially in section, of another embodiment of a device for injecting dry smoke into a food product;

FIG. 5 is a schematic, cross-sectional side view of an oven with a device for injecting dry smoke into a food product positioned within an oven cavity;

FIG. 6 is a perspective view of a smoke injector impaled into meat and having a smoke ring combined therewith;

FIG. 7 is a longitudinal cross-sectional view of the combination smoke injector and smoke ring of FIG. 6 taken along the line 7-7;

FIG. 8 is a perspective view of a housing and lid for a smoker assembly;

FIG. 9A is a schematic view of a smoker assembly, partially in section, including the housing shown in FIG. 8 wherein a second smoke injector is shown in an installed position;

FIG. 9B is a schematic view as in FIG. 9A, wherein the second smoke injector has been removed and is not installed;

FIG. 10 is a perspective view of a housing for a smoker assembly with a smoke injector being horizontally oriented along a longitudinal axis that is parallel to a bottom wall of the housing.

### DETAILED DESCRIPTION

Relative language used herein is best understood with reference to the drawings, in which like numerals are used to identify like or similar items or features.

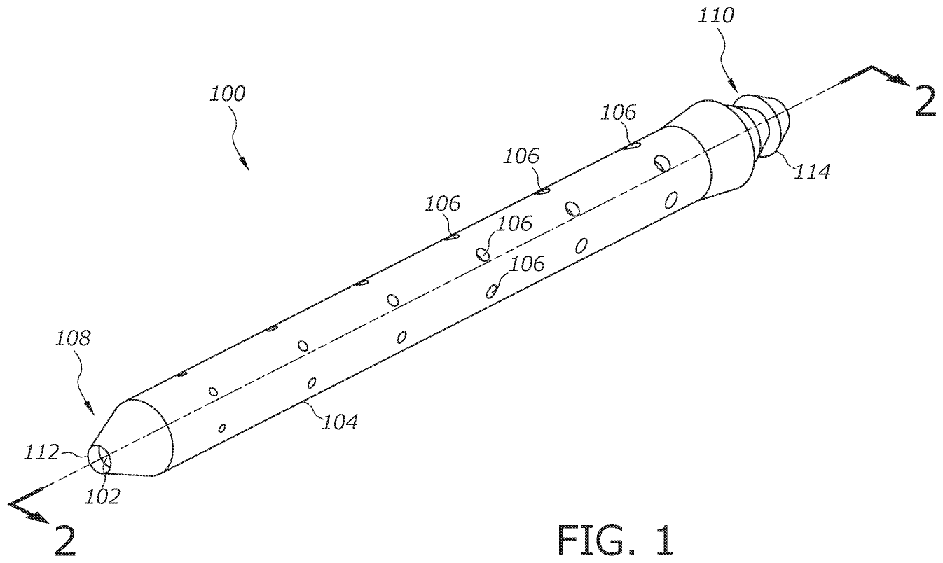

Referring now to the drawings, FIG. 1 schematically depicts a smoke injector 100 for injecting dry smoke into a food product. The smoke injector 100 includes a smoke-injector conduit 102 defined by an external wall 104 having a plurality of apertures 106 formed therein. The plurality of apertures 106 provide fluid communication from the smoke-injector conduit 102 to a region outside and adjacent to the smoke injector 100. As shown, the smoke injector 100 is an elongated hollow tube having a first end 108 and an opposing second end 110. While the smoke injector 100 is shown as having a cylindrical configuration, it is to be understood that other cross-sectional geometric configurations are contemplated (e.g., square, rectangle, triangle, pentagon, etc.). The first end 108 is conically shaped and includes an end aperture 112 formed in a tip of the first end 108. The second end 110 comprises an inlet connecting port 114 configured to fluidly connect the smoke injector 100 to a transfer conduit, as will be further explained below.

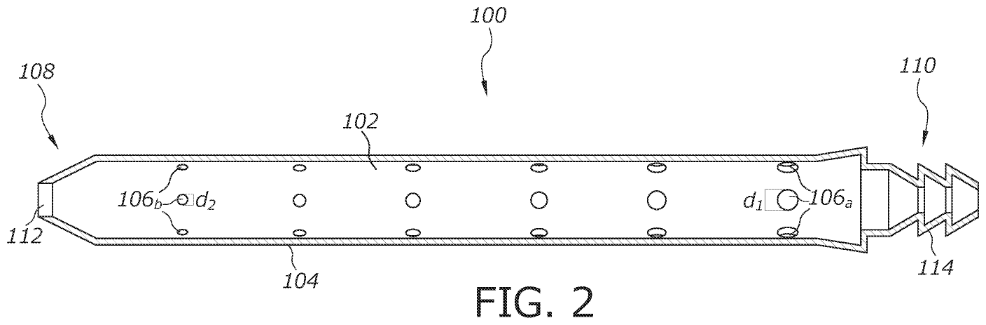

FIG. 2 depicts a longitudinal cross-sectional view of the smoke injector 100. As seen in the figure, the plurality of apertures 106 includes a first group of apertures 106a and a second group of apertures 106b that are axially spaced from the first group of apertures 106a. The apertures within the first group of apertures 106a are circumferentially spaced from one another. The apertures within the second group of apertures 106b also are circumferentially spaced from one another. Further, in the illustrated embodiment each aperture in the first group of apertures 106a has a common first diameter d₁, and each aperture in the second group of apertures 106b has a common second diameter d₂. The first diameter d₁ is greater than the second diameter d_{z}.

As shown, the first group of apertures 106a is positioned closest to second end 110 of the smoke injector 100 whereas the second group of apertures 106b is located closest to the first end 108 of the smoke injector 100. Additional groups of apertures are interposed between the first and second groups of apertures 106a, 106b. In a preferred embodiment, all apertures within each group thereof share a common diameter and are spaced circumferentially about the smoke injector 100 in the external wall 104 thereof. Also preferably, the diameters of the apertures in each successive group of apertures moving in an axial direction from the second end 110 to the first end 108 is smaller than the preceding group of apertures. That is, the first group of apertures 106a nearest the second end 110 has the largest diameter (i.e., d₁) among the groups of apertures, and each successive group of apertures toward the first end 108 has a progressively smaller common diameter, until reaching the second group of apertures 106b, which has the smallest diameter (i.e., d₂). It is to be understood that there can be any number of groups of apertures disposed between the first and second groups of apertures 106a, 106b.

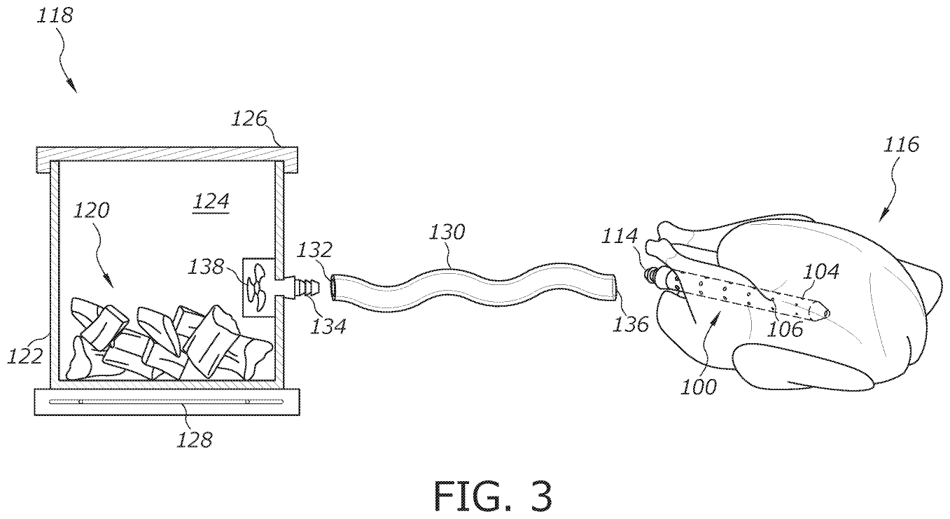

Moving on to FIG. 3, a device for injecting dry smoke into a food product 116 is shown. The device includes the smoke injector 100, which is shown impaling the food product 116. The device further includes a smoke reservoir 118 configured to house a dry smoking media 120 therein. Specifically, the smoke reservoir 118 includes a reservoir housing 122 that defines a storage space 124 therein. The dry smoking media 120 is located within the storage space 124 and a lid 126 provides selective access thereto. The lid 126 can be a separate and distinct structure with respect to the reservoir housing 122 such that the lid 126 can be completely removed from the reservoir housing 122 which promotes independent cleaning. Alternatively, the lid 126 can be hinged to the reservoir housing 122 such that the lid 126 remains connected to the reservoir housing 122 and a user pivots the lid 126 about the reservoir housing 122 to gain access to the storage space 124.

As shown in FIG. 3, the device may include a heating element 128 configured to apply heat to the smoke reservoir 118. That is, the heating element 128 provides heat to the smoke reservoir 118 to produce dry smoke from the dry smoking media 120 housed therein. It is to be understood that the device is a dry system in that no liquid is used to produce the smoke. Rather, a solid material is heated to generate dry smoke (e.g., via pyrolysis) that can be carried to the smoke injector(s) 100 via a flowing stream of air. In this manner, the amount of moisture introduced into the food product 116 as a result of smoke introduction is minimized. The heating element 128 can be integrally formed with the reservoir housing 122 such that the heating element 128 is embedded in (or even forms a base of) the reservoir housing 122 (i.e., cannot be readily removed). Alternatively, the reservoir housing 122 and the heating element 128 can be separate and distinct parts such that the reservoir housing 122 rests on the heating element 128 in an installed position and is capable of being completely removed (i.e., lifted off) therefrom. For example the reservoir housing 122 can be configured to rest on and be heated by a cooktop burner, such that the cooktop can be operated to generate dry smoke that can be fed to a smoke injector 100 via a transfer conduit 130 to a food product 116 being cooked in the oven cavity of the same (or a different) appliance.

The transfer conduit 130 provides fluid communication between the smoke injector 100 and the smoke reservoir 118. Specifically, the transfer conduit 130 includes an inlet end 132 configured to removably connect the transfer conduit 130 to an outlet connecting port 134 of the reservoir housing 122. The transfer conduit 130 further includes an outlet end 136 configured to removably connect the transfer conduit 130 to the inlet connecting port 114 of the smoke injector 100. In this manner, the smoke reservoir 118 is a separate and distinct structure with respect to the smoke-injector conduit 102 of the smoke injector 100, and the transfer conduit 130 provides the fluid communication between the smoke reservoir 118 and the smoke injector 100.

As shown, the inlet connecting port 114 of the smoke injector 100 and the outlet connecting port 134 of the smoke reservoir 118 can be formed as or include barbed hose adapters such that respective ends of the transfer conduit 130 slide over the barbs of the respective port 114 or 134 to form air-tight connections therebetween in order to conduct smoke (carried in a fluid stream, such as air) from the outlet connecting port 134 of the smoke reservoir 118 to the inlet connecting port 114 of the smoke injector 100. It is to be understood that other configurations of hose connectors are contemplated (e.g., quick-connect fittings, threaded screw-type connections, hose-clamp connections etc.).

The device further includes a first fan 138 that directs the dry smoke produced from the dry smoking media 120 located in the smoke reservoir 118 into the smoke-injector conduit 102 of the smoke injector 100. In other words, the first fan 138 draws in the dry smoke produced within the storage space 124 in the smoke reservoir 118 and actively forces said dry smoke into the smoke-injector conduit 102 of the smoke injector (via the transfer conduit 130) such that the dry smoke is eluted through the plurality of apertures 106 formed through the external wall 104 of the smoke injector 100. In this manner, the dry smoke is injected into the interior of the food product 116 impaled by the smoke injector 100.

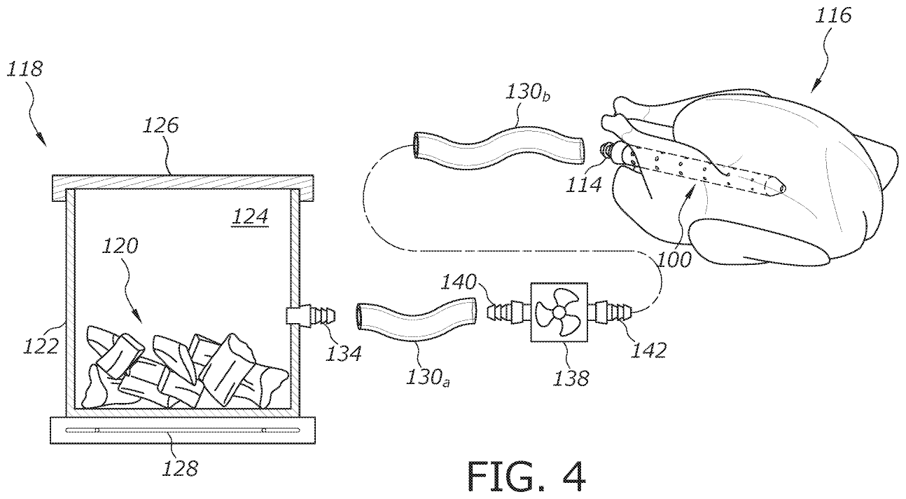

In the embodiment shown in FIG. 3, the first fan 138 is located within the smoke reservoir 118. Specifically, the first fan 138 is shown positioned within the storage space 124 of the smoke reservoir 118 and disposed directly adjacent the outlet connecting port 134 on a sidewall of the reservoir housing 122. In another embodiment, as shown in FIG. 4, the first fan 138 can be disposed between the smoke reservoir 118 and the smoke injector 100 in-series with the transfer conduit 130. Specifically, the transfer conduit 130 can be split into a first transfer conduit 130a and a second transfer conduit 130b, wherein the first transfer conduit 130a fluidly connects the smoke reservoir 118 and the first fan 138 (or a fan housing) and the second transfer conduit 130b fluidly connects the first fan 138 (or fan housing) and the smoke injector 100. To achieve this configuration, the first fan 138 is disposed within a fan housing that includes a fan inlet connecting port 140 and a fan outlet connecting port 142 such that the first transfer conduit 130a is connected between the outlet connecting port 134 of the smoke reservoir 118 and the fan inlet connecting port 140, and the second transfer conduit 130b is connected between the fan outlet connecting port 142 and the inlet connecting port 114 of the smoke injector 100. It will be appreciated that the first fan 138 can be disposed in other locations. For example, the first fan 138 may be located in or upstream of the reservoir housing 122 in order to drive air into the reservoir housing 122, which then will exit (together with entrained smoke) via the outlet connecting port 134 into the transfer conduit 130. Still other configurations are possible and contemplated.

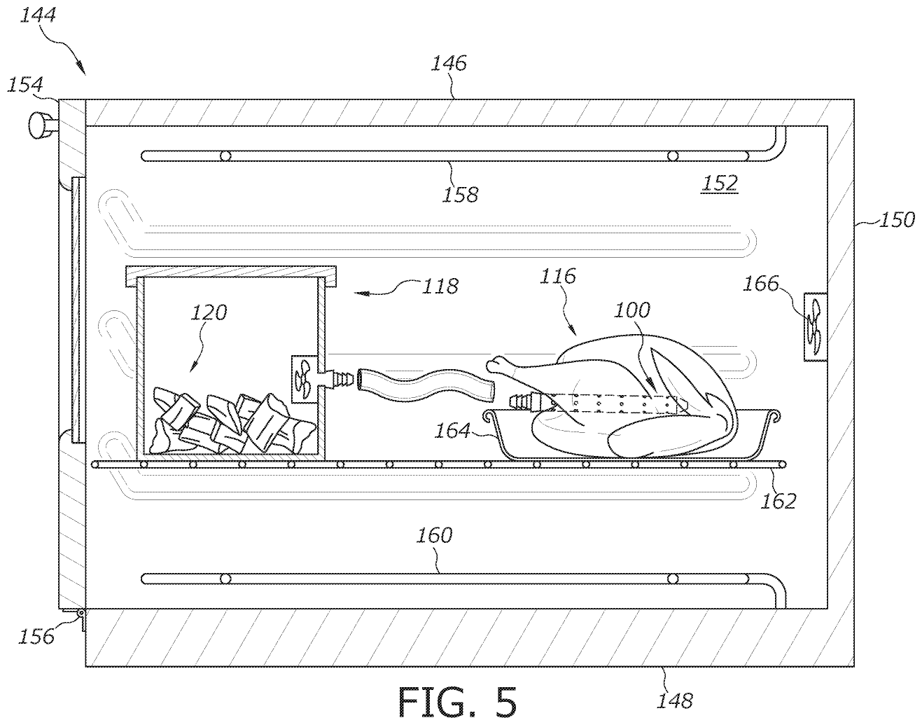

Moving on to FIG. 5, the device is shown within an oven 144. Specifically, the oven 144 includes a top wall 146, bottom wall 148, sidewalls (not shown in this view), as well as a front wall and a rear wall 150, all of which together define an oven cavity 152. A door 154 is rotatably secured to the bottom wall 148 by a hinge 156 and forms all or part of the front wall, to provide selective access to the oven cavity 152. The oven 144 includes first and second oven heating elements 158, 160 that are disposed adjacent the top and bottom walls 146, 148, respectively. It is to be understood that the oven cavity 152 can include only one of the first or second oven heating element 158, 160, or even additional heating elements.

The device can be removably installed within the oven cavity 152. That is, the smoke reservoir 118 sits directly on an oven rack 162 within the oven cavity 152 and the food product 116 is contained within a cooking receptacle 164 that likewise sits directly on the same or a different oven rack 162. In FIG. 5, the smoke reservoir 118 does not include the heating element 128 shown in FIGS. 3-4. Rather, the first and/or second oven heating elements 158, 160 that supply cooking power to cook the food product 116 also supply the heat to the smoke reservoir 118 to produce dry smoke from the dry smoking media 120 therein. As further shown, an oven fan 166 is disposed within the oven cavity 152 and is located adjacent one of the walls (e.g., the rear wall 150). In the event that at least one of the plurality of apertures 106 is not located within the food product 116 when impaled by the smoke injector 100, the oven fan 166 circulates any leaked dry smoke within the oven cavity 152.

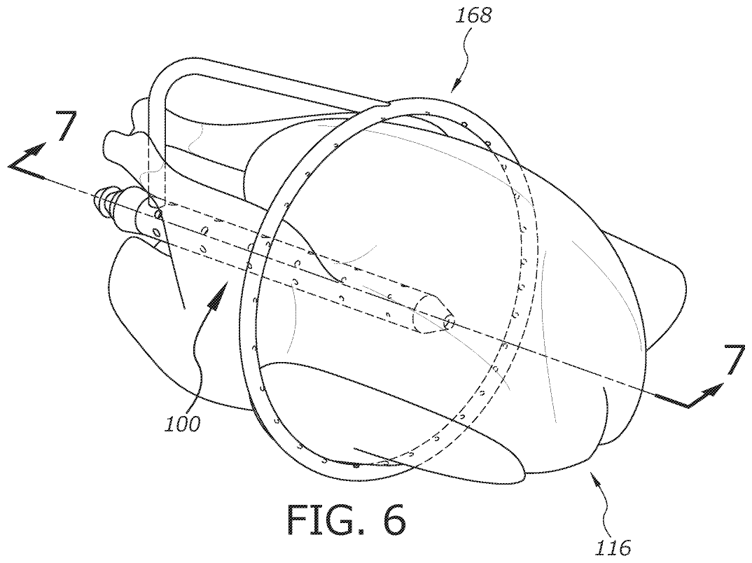

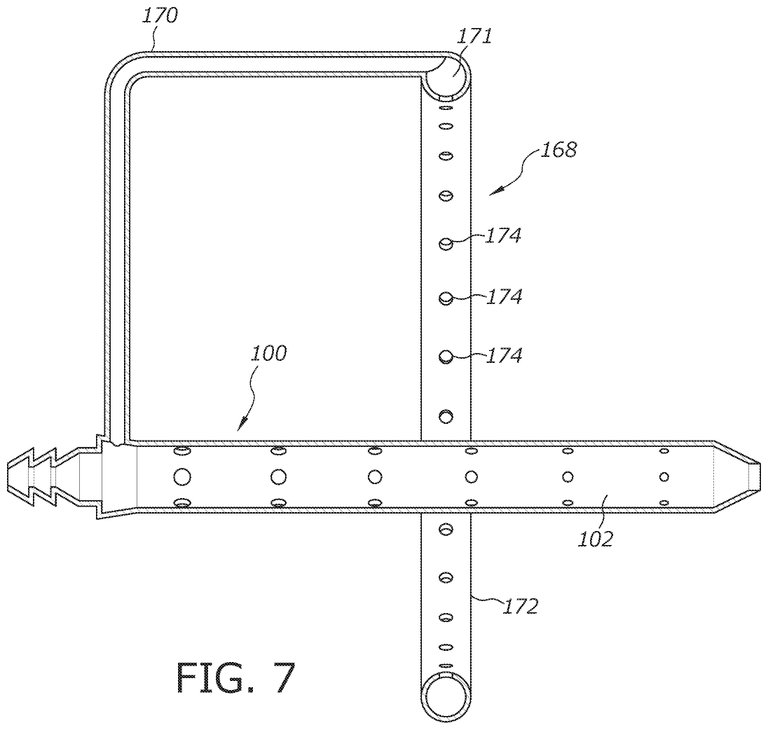

Moving on to FIG. 6, yet another embodiment is shown where the device further includes a smoke ring 168 that circumferentially surrounds the smoke injector 100 and the food product 116 when impaled by said smoke injector 100. With reference to FIG. 7, the smoke ring 168 is provided in fluid communication with the smoke injector 100 via a structural tube 170 that maintains the smoke ring 168 at a predetermined radius from the smoke injector 100, which is coaxial therewith. That is, the structural tube 170 is a rigid element that extends outward and away from the smoke injector 100. Moreover, the smoke ring 168 includes a duct 171 and an outer wall 172 having a plurality of ring apertures 174 formed therethrough. In operation, when dry smoke is forced into the smoke-injector conduit 102, dry smoke will likewise travel through the structural tube 170 and into the duct 171 of the smoke ring 168. The plurality of ring apertures 174 communicate with the duct 171 to introduce said dry smoke to an external surface of the food product 116 when the smoke ring 168 surrounds said food product 116 (as shown in FIG. 6). In this manner, dry smoke eluted from the smoke-injector conduit 102 introduces smoke for flavoring within the food product 116, to ensure that the smoke flavor penetrates into the interior of the food product 116, while dry smoke eluted from the smoke ring 168 ensures that the exterior of the food product 116 also is exposed to dry smoke, and is likewise flavored thereby.

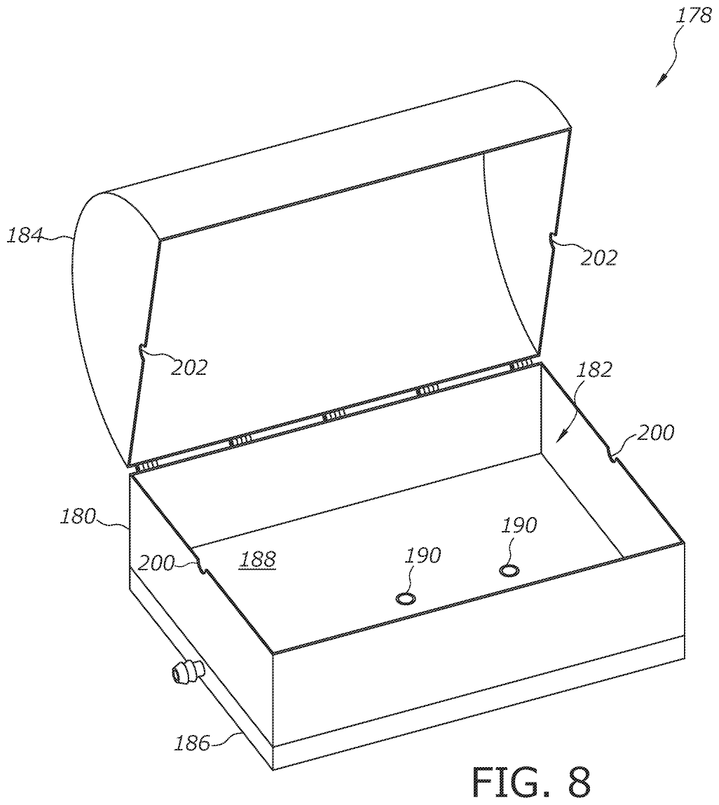

Referring now to FIGS. 8-10, a smoker assembly 178 for injecting dry smoke into a food product is shown. The smoker assembly 178 includes a housing 180 that defines a smoking space 182 therein for housing the food product to be smoked. A top wall or hood 184 is removably or closably secured to the housing 180 to provide selective access to the smoking space 182, which will be enclosed and substantially isolated from the space exterior to the housing 180 when the hood 184 is secured or closed to the housing 180. Further, a pan 186 is disposed below a bottom wall 188 of the smoking space 182. The pan 186 is removably secured to the housing 180 such that the pan 186 can be completely removed from the housing 180. Further, the bottom wall 188 of the housing 180 includes apertures 190 formed therein. While only two apertures 190 are shown, it is contemplated that the bottom wall 188 may include any number of apertures.

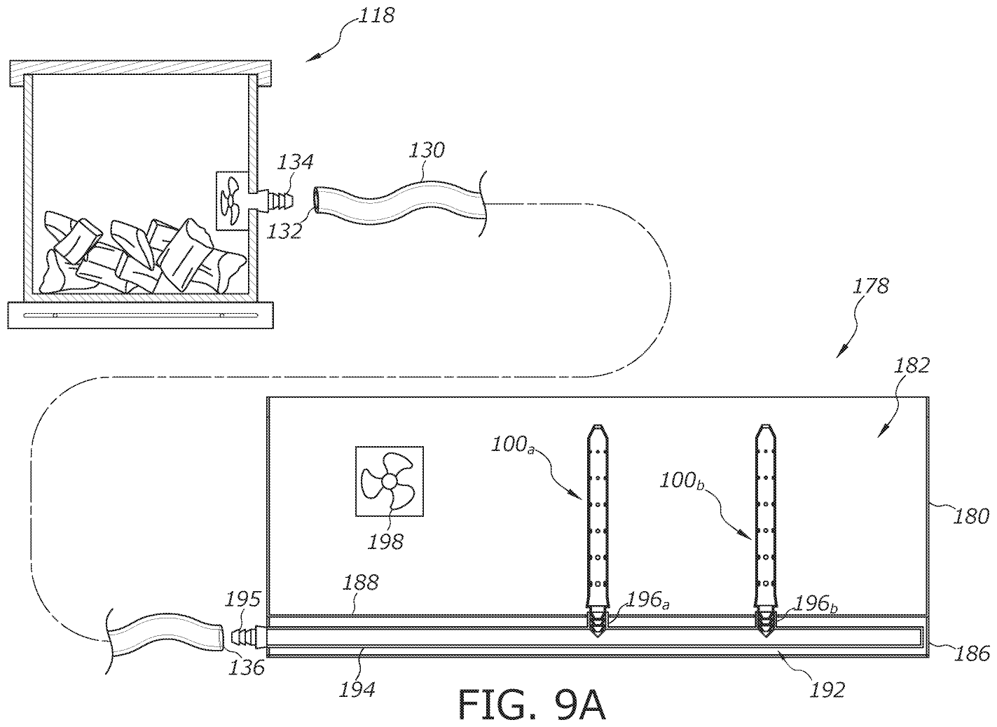

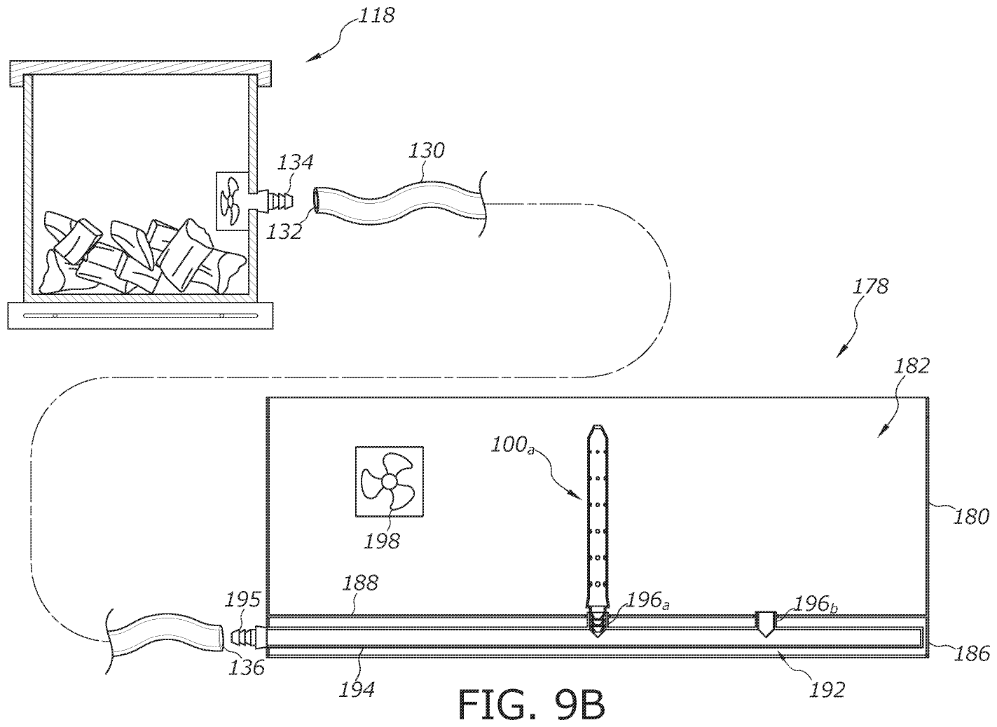

As best shown in FIGS. 9A-9B, a cavity 192 is defined between the pan 186 and the underside of the bottom wall 188. A manifold 194 extends within the cavity 192 and includes a manifold inlet port 195 and manifold outlet ports 196a, 196b which correspond to the locations of the respective apertures 190 formed in the bottom wall 188 of the housing 180.

As further shown, the smoker assembly 178 includes the aforementioned smoke reservoir 118. Specifically, the inlet end 132 of the transfer conduit 130 is removably secured to the outlet connecting port 134 of the smoke reservoir 118 and the outlet end 136 of the transfer conduit 130 is removably secured to the manifold inlet port 195 of the manifold 194. Moreover, each manifold outlet port 196 is configured to removably couple a smoke injector 100 thereto.

Referring first to FIG. 9A, a first smoke injector 100a is coupled to a first manifold outlet port 196a of the manifold 194 and a second smoke injector 100b is coupled to a second manifold outlet port 196b of the manifold 194. In this manner, the first and second smoke injectors 100a, 100b are in fluid communication with the smoke reservoir 118. Moreover, either of the first and/or second smoke injectors 100a, 100b can be removed from its respective manifold outlet port 196a, 196b. For example, as shown in FIG. 9B, the first smoke injector 100a is coupled to the first manifold outlet port 196a of the manifold 194 whereas the second smoke injector 100b (not shown) is disconnected and uninstalled from the second manifold outlet port 196b.

In other words, when the second smoke injector 100b is installed (as shown in FIG. 9A), the second smoke injector 100b is in fluid communication with the smoke reservoir 118 such that dry smoke is eluted through a plurality of apertures formed in an external wall of the second smoke injector 100b in order to introduce said dry smoke to an interior of a food product when impaled by the second smoke injector 100b. When the second smoke injector 100b is uninstalled (as shown in FIG. 9B), the second smoke injector 100b is disconnected from the manifold 194 such that the second manifold outlet port 196b selectively exhausts dry smoke to the smoking space 182. In this manner, the dry smoke exhausted by the second manifold outlet port 196b flows into the smoking space 182 of the housing 180 and engages an outer surface of the food product to be cooked. As further shown in FIGS. 9A-9B, a smoker assembly fan 198 is located within (or communicates with) the smoking space 182, e.g. on a wall of the housing 180, and is configured to circulate the dry smoke within the smoking space 182. It is further contemplated that the smoker assembly fan 198 can be positioned at alternative locations (e.g., the hood 184, the bottom wall 188, outside the housing 180, etc.).

Returning to FIG. 8, opposing side walls of the smoker assembly 178 include opposing and aligned housing slots 200 formed therein. In the illustrated embodiment, respective and cooperating hood slots 202 are formed in opposing sidewalls of the hood 184, which correspond to and are aligned with the housing slots 200 in the housing sidewalls such that, when the hood 184 is closed or secured to the housing 180, the hood slots 202 align with the housing slots 200. The housing and hood slots 200, 202 are shown having a semi-circular shape such that, in the closed/secured position of the hood 184, the cooperating housing and hood slots 200, 202 form respective and aligned circular openings opposing one another at opposite sides of the housing 180.

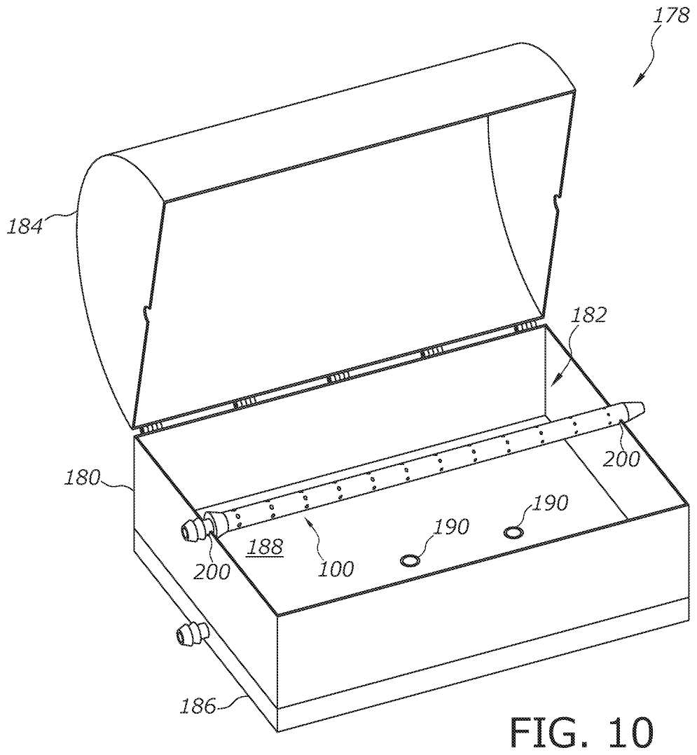

As shown in FIG. 10, a horizontally oriented smoke injector 100 can be seated on the housing slots 200 such that the smoke injector 100 extends laterally across the smoking space 182, essentially as a spit for impaling and supporting a food product thereon within the housing 180. Specifically, the smoke injector 100 is horizontally oriented along a longitudinal axis that is parallel to the bottom wall 188 of the housing. In this manner, a food product can be impaled by the smoke injector 100 within the smoker assembly 178, similar to a conventional spit. To prevent dry smoke from being exhausted outside of the smoker assembly 178, the end aperture 112 of the smoke injector 100 can be blocked or capped such that no dry smoke passes therethrough.

The invention has been described with reference to the example embodiments described above. Modifications and alterations will occur to others upon a reading and understanding of this specification. Example embodiments incorporation one or more aspects of the invention are intended to include all such modifications and alterations insofar as they come within the scope of the appended claims.

What is claimed is:

1. A device for injecting dry smoke into a food product, the device comprising:
a smoke injector configured to impale a food product and comprising an external wall defining a smoke-injector conduit, a plurality of apertures in said external wall providing fluid communication therethrough;
a smoke reservoir remote from and in fluid communication with the smoke-injector conduit, the smoke reservoir being configured to house dry smoking media therein; and
a first fan for directing dry smoke produced from dry smoking media in said smoke reservoir into the smoke-injector conduit such that the dry smoke is eluted through said plurality of apertures in order to introduce said dry smoke to an interior of the food product when impaled by said smoke injector.

2. The device of claim 1, the smoke injector comprising an elongated hollow tube having a first end and a second end, said first end being conically shaped with an end aperture formed at a tip of the first end.

3. The device of claim 2, further comprising a transfer conduit providing said fluid communication between said smoke reservoir and said smoke-injector conduit, said transfer conduit having an inlet end removably coupled to the smoke reservoir and an outlet end removably coupled to the second end of the smoke injector.

4. The device of claim 3, further comprising a heating element configured to apply heat to the smoke reservoir.

5. The device of claim 3, the first fan being disposed between the smoke reservoir and the smoke injector in-line with said transfer conduit.

6. An oven for cooking a food product, the oven comprising:
an oven cavity;
a door configured to provide selective access to the oven cavity;
the device of claim 1 being removably installed within the oven cavity; and
a second fan configured to circulate the dry smoke within the oven cavity.

7. The device of claim 1, said first fan being located within the smoke reservoir.

8. The device of claim 1, the smoke injector comprising an elongated hollow tube having a first end and a second end, said plurality of apertures comprising:
a first group of apertures circumferentially spaced from one another, each aperture in the first group of apertures having a first diameter; and
a second group of apertures circumferentially spaced from one another, each aperture in the second group of apertures having a second diameter,
said first group of apertures being axially spaced from said second group of apertures, and said first diameter being greater than said second diameter.

9. The device of claim 8, said first end of the elongated hollow tube being conically shaped with an end aperture formed in a tip of the first end.

10. The device of claim 1, further comprising a smoke ring concentric with, surrounding and in fluid communication with the smoke injector, the smoke ring comprising an outer wall defining a duct therein and having a plurality of ring apertures providing communication through the outer wall of said smoke ring in order to introduce said dry smoke to an external surface of the food product when surrounding said food product.

11. A smoker assembly for injecting dry smoke into a food product, the smoker assembly comprising:
a housing defining a smoking space therein for the food product to be smoked, and a pan disposed below a bottom wall of said housing such that a cavity is defined between the bottom wall and the pan;
a first smoke injector having a first external wall defining a first smoke-injector conduit and having a plurality of first apertures formed therein to provide communication through said first external wall, said first external wall having a first end and a second end, said first end of said first external wall being conically shaped and having a first end aperture formed in a tip thereof;
a manifold extending within the cavity and including a first outlet port for removably coupling the first smoke injector;
a smoke reservoir remote from and in fluid communication with the manifold, the smoke reservoir being configured to house dry smoking media therein; and
a first fan for directing dry smoke produced from dry smoking media in said smoke reservoir into the manifold such that the dry smoke is delivered from said manifold and eluted through said plurality of first apertures in order to introduce said dry smoke to an interior of a food product within said smoking space when impaled by said first smoke injector.

12. The smoker assembly of claim 11, further comprising:
a top wall removably secured to the housing that provides selective access to the smoking space;
a second fan configured to circulate the dry smoke within the smoking space; and
a heating element configured to supply heat to the smoke reservoir.

13. The smoker assembly of claim 11, the first smoke injector comprising an elongated hollow tube, said plurality of first apertures comprising:
a first group of apertures circumferentially spaced from one another, each aperture in the first group of apertures having a first diameter; and
a second group of apertures circumferentially spaced from one another, each aperture in the second group of apertures having a second diameter,
said first group of apertures being axially spaced from said second group of apertures, and said first diameter being greater than said second diameter.

14. The smoker assembly of claim 11, the manifold comprising a second outlet port for removably coupling a second smoke injector such that,
when the second smoke injector is installed, it is in fluid communication with the smoke reservoir such that said dry smoke is eluted through a plurality of second apertures formed in a second external wall of the second smoke injector in order to introduce said dry smoke to the interior of the food product when impaled by the second smoke injector.

15. The smoker assembly of claim 11, further comprising a smoke ring concentric with, surrounding and in fluid communication with the first smoke injector, the smoke ring comprising an outer wall defining a duct therein and having a plurality of ring apertures providing communication through the outer wall of said smoke ring in order to introduce dry smoke to an external surface of the food product when surrounding said food product.

16. The smoker assembly of claim 11, the first fan being disposed between the smoke reservoir and the manifold.

17. The smoker assembly of claim 11, the first fan being located within the smoke reservoir.

18. A smoker assembly for injecting dry smoke into a food product, the smoker assembly comprising:
a housing defining a smoking space therein for housing the food product to be smoked;
a smoke injector comprising an elongated hollow tube with a plurality of apertures providing communication between a smoke-injector conduit formed within said tube and a space outside of said tube, the smoke injector extending between opposing side walls of and through said housing;
a smoke reservoir remote from and in fluid communication with the smoke-injector conduit, the smoke reservoir configured to house a dry smoking media therein; and
a first fan for directing dry smoke produced from the dry smoking media in said smoke reservoir into the smoke-injector conduit such that the dry smoke is eluted through said plurality of apertures in order to introduce said dry smoke to an interior of the food product when impaled by said smoke injector.

19. The smoker assembly of claim 18, the smoke injector comprising a first end and a second end, said first end being conically shaped with an end aperture formed in a tip of the first end, and said plurality of apertures comprising:
a first group of apertures circumferentially spaced from one another, each aperture in the first group of apertures having a first diameter; and
a second group of apertures circumferentially spaced from one another, each aperture in the second group of apertures having a second diameter,
said first group of apertures being axially spaced from said second group of apertures, and said first diameter being greater than said second diameter.

20. The smoker assembly of claim 18, further comprising a smoke ring concentric with, surrounding and in fluid communication with the smoke injector, the smoke ring comprising an outer wall defining a duct therein and having a plurality of ring apertures providing communication through a wall of said tube between said duct and a space outside of said tube in order to introduce said dry smoke to an external surface of the food product when surrounding said food product.
